(19) United States
(12) Patent Application Publication
(10) Pub. No.: US 2026/0201108 A1
(43) Pub. Date: Jul. 16, 2026

(54) COMPOSITION CONTAINING ISOCYANATE AND ISOCYANURATE GROUPS, AND RIGID PUR/PIR FOAMS PRODUCED THEREFROM

(71) Applicant: Covestro Deutschland AG, Leverkusen (DE)

(72) Inventors: Christos Karafilidis, Leverkusen (DE); Nicole Welsch, Rosrath (DE); Marc Schumacher, Bergheim (DE); Sabine Dippe, Leverkusen (DE); Rene Abels, Koln (DE)

(21) Appl. No.: 19/137,480

(22) PCT Filed: Dec. 11, 2023
(86) PCT No.: PCT/EP2023/085176

§ 371 Date: Jun. 10, 2025

(30) Foreign Application Priority Data
Dec. 13, 2022 (EP) 22212997.5

(51) Int. Cl. C08G 18/80; B32B 5/18; B32B 27/40; C08J 9/12; C08J 9/14

(52) U.S. Cl. CPC C08G 18/807; B32B 5/18; B32B 27/40; C08J 9/125; C08J 9/127; C08J 9/141; B32B 2266/0278; C08G 2110/0025; C08J 2203/10; C08J 2203/14; C08J 2203/182; C08J 2205/10; C08J 2375/08

(57) ABSTRACT

This disclosure provides compositions containing isocyanate and isocyanurate groups by allowing a pMDI to react in the presence of a trimerization catalyst, and the process for producing a rigid PUR/PIR foam from this composition. The disclosure further relates to the process for producing the compositions containing isocyanate and isocyanurate groups, to the production of rigid PUR/PIR foams from these compositions, to the rigid foams themselves, and to the use of such rigid foams.

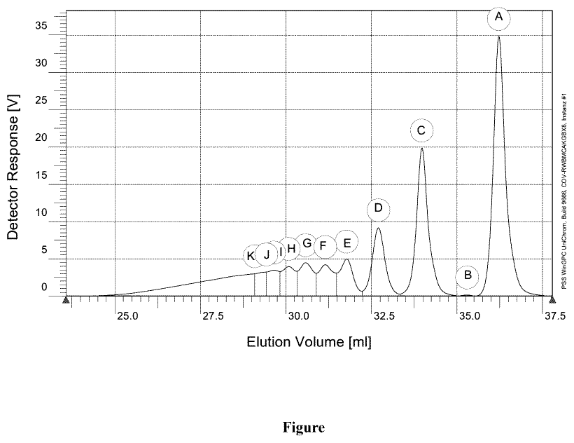

### CROSS REFERENCE TO RELATED APPLICATIONS

This application is a U.S. national stage application, filed under 35 U.S.C. § 371, of International Application No. PCT/EP2023/085176, which was filed on Dec. 11, 2023, and which claims priority to European Patent Application No. 22212997.5, which was filed on Dec. 13, 2022. The entire contents of each are hereby incorporated by reference into this specification.

### FIELD

The present invention relates to an isocyanate- and isocyanurate-containing composition for production of rigid PUR/PIR foams and to production of the isocyanate- and isocyanurate-containing compositions by partial trimerization of polymeric MDI (pMDI). It further relates to the production of rigid PUR/PIR foams from these compositions, to the rigid foams themselves and to the use of such rigid foams.

### BACKGROUND

To produce thermally insulating foams, such as are employed in the cladding of façades, increasing use is made, for the purposes of improving fire safety, of polyisocyanurate-polyurethane foam systems (PUR/PIR foams) which are produced through markedly superstoichiometric use—based on the polyol component—of the polymeric polyisocyanate customary for rigid foam production. The polymeric polyisocyanate employed therefore has a decisive impact on the properties of the rigid foam. An important technical property, in addition to final properties such as insulation efficiency and final strength, is also mechanical strength shortly after production of the rigid foam. This determines the time after which the hard foam can be mechanically handled and stacked.

It is known that the time required to cure a PUR/PIR foam can be influenced by various factors, inter alia through the use of oligomeric (polynuclear) polyisocyanates. The synthesis of polynuclear isocyanurate structures is achieved by trimerization of polyisocyanates.

U.S. Pat. No. 4,743,627 describes PUR/PIR foams of particularly low coloration from compositions containing isocyanate and isocyanurate groups. The procedure described therein comprises the steps of: (a) trimerizing polymeric MDI in the presence of a trimerization catalyst to obtain an isocyanurate-containing polyisocyanate; (b) deactivating the trimerization catalyst; and (c) mixing the isocyanurate-containing polyisocyanate with monomeric MDI to form an end product which has a viscosity comparable to the viscosity of a standard pMDI and a binuclear content of at least 60% by weight. The final product is used in the production of foams having a lighter colour than foams based on standard pMDI. The disadvantage of step c), mixing with monomeric MDI, is that it reduces the isocyanate functionality of the mixture, thus having an adverse effect on the final properties such as the strength of the rigid PUR/PIR produced therefrom.

US 2009/105359 A1 relates to a process for producing a liquid, isocyanurate-modified pMDI having a controlled viscosity. The process comprises the steps of: (a) trimerizing “conventional pMDI”, a trimer-free mixture of monomeric and oligomeric MDI having a viscosity between 30 and 300 mPa*s, in the presence of a trimerization catalyst to obtain an isocyanurate-containing pMDI having a viscosity at 25° C. in the range from 2000 mPas to 200 000 mPa*s; (b) deactivating the catalyst with a catalyst deactivator to obtain a mixture containing isocyanurate-modified pMDI and deactivated catalyst; and (c) mixing the mixture from step (b) with an amount of trimer-free pMDI sufficient to obtain a mixture having a viscosity at 25° C. in the range from 400 mPas to 20 000 mPas and a content of free NCO groups comparable to conventional pMDI having a viscosity between 30 and 1000 mPa*s.

The disadvantage is that this three-step process for producing isocyanurate-containing pMDI, which proceeds via a high viscosity pMDI in an intermediate step, results in defects in the production of insulation panels.

WO 2017/046274 A1 discloses a process for producing rigid polyurethane-polyisocyanurate foams (rigid PUR/PIR foams) using an isocyanate blend of predominantly monomeric MDI with polymeric MDI which is then partially trimerized. The isocyanate blends employed according to the invention contain 15-25% by weight of isocyanurate groups and have viscosities of >1000 mPa*s at 25° C.—blends with lower viscosities and/or higher isocyanurate contents prove to be detrimental in this context, for example in terms of storage stability.

JP H06 256460 A, JP 2008 260843 A, JP H08 73557 A, JP H08 92346 A and JP H08 120048 A disclose isocyanurate-modified polyisocyanates and foams produced therefrom. Production of the modified polyisocyanates employs relatively high catalyst concentrations (greater than 0.5% by weight) and the results do not show a linear relationship between NCO contents, viscosities and isocyanurate contents. An MDI having a viscosity of 130 mPa*s (25° C.) is employed in each case. Catalyst concentrations above 0.5% by weight result in a reactivity that is difficult to control.

JP S59 163357 A likewise discloses the production of modified polyisocyanates with high catalyst quantities, these being stopped thermally rather than chemically. However this has the disadvantage that the catalyst residues that have not been chemically deactivated can adversely affect the further reaction to afford the polyurethane. The trimerization reaction moreover continues for a period during the thermal stopping, as a result of which it is hardly possible to establish a particular product viscosity in a controlled manner.

DE 691 16 583 T2 discloses the trimerization of polyisocyanates with the catalyst tetramethylguanidine, an iminourea derivative. This catalyst cannot be stopped with acid chlorides or hydrochloric acid, which is why it is necessary to use the stopper methylsulfonic acid which has an adverse effect on the corrosivity of the composition.

EP 3 974 460 A1 discloses an isocyanate formulation containing a free-radical initiator (tert-butyl peroxybenzoate) and an inhibitor (dibutylhydroxytoluene), wherein the inhibitor is added at the same time as the free-radical initiator. During the reaction of the isocyanate formulation with a polyol the free-radical initiator is said to undergo thermal decomposition into free radicals at elevated temperature and initiate a free-radical polymerization of olefins. The inhibitor is already added with the free-radical initiator in order that the isocyanate formulation remains stable and does not increase in viscosity and ultimately solidify prior to use, i.e. during storage. The present invention moreover describes no free-radical initiators, especially no peroxides or azo compounds.

WO 2020/221662 A1 likewise discloses the trimerization of isocyanates using a free-radical initiator. The reaction is not stopped and no stopper is added. As a result, the trimerization reaction can continue unrestricted until gelation and the resulting isocyanate cannot be used for a foaming reaction.

### SUMMARY

It is an object of the present invention starting from the aforementioned prior art to provide a polyisocyanate component which makes it possible to produce rigid PUR/PIR foams having good initial strength which allow early handling and stackability of the insulation panels produced therefrom and exhibit good flame retardancy. At the same time the polyisocyanate component shall overcome the disadvantages of the processes described in the prior art (lack of storage stability, inadequate foam properties, defects in produced panels).

This object was surprisingly able to be achieved by an isocyanurate-containing pMDI having a viscosity <2000 mPa*s at 25° C., especially <1000 mPa*s at 25° C., and a number-average molecular weight Mn of >350 g/mol which is directly obtainable by trimerization of a conventional polymeric MDI having a content of monomeric MDI of <55% by weight, especially <50% by weight, and a viscosity of 130-400 mPa*s, preferably of 140 to 400 mPa*s, at 25° C., more preferably of 140-300 mPa*s at 25° C., and contains 5-<13% by weight of isocyanurate groups.

### BRIEF DESCRIPTION OF THE DRAWING

The FIGURE shows an RI signal of gel permeation chromatogram of ISOCYANATE 1 with labelling of peaks.

### DETAILED DESCRIPTION

The invention therefore relates to a process for producing an isocyanate- and isocyanurate-containing composition A2 comprising the steps of:
1) reacting a polyisocyanate A1 in the presence of a trimerization catalyst and
2) stopping the reaction from step 1) using a suitable stopper to obtain the composition A2;
wherein the trimerization catalyst is not an iminourea, a derivative of iminourea or a free-radical initiator and the concentration of the employed trimerization catalyst is <0.50% by weight based on A1, in particular <0.45% by weight, more preferably <0.40% by weight and very particularly preferably <0.30% by weight and
wherein the polyisocyanate A1 employed in step 1) is polymeric MDI having a content of monomeric diphenylmethane diisocyanate of <55% by weight, especially preferably 30-50% by weight of monomeric diphenylmethane diisocyanate, and a viscosity of 140-400 mPa*s (determined according to DIN 53019-1:2008-09 without solvent) and
wherein step 2) is performed when the reaction mixture from step 1) comprises 5-<13% by weight of isocyanurate groups and has a viscosity of <2000 mPa*s at 25° C. (determined according to DIN 53019-1:2008-09 without solvent).

In the context of the present application “oligomeric MDI” is to be understood as meaning a polyisocyanate mixture composed of polynuclear homologs of MDI which have at least 3 aromatic nuclei and an NCO-functionality of at least 3.

In the context of the present invention the term “polymeric diphenylmethane diisocyanate”, “polymeric MDI” or pMDI is used to describe a mixture of oligomeric MDI and optionally monomeric MDI. The monomer content of a polymeric MDI is typically in the range of 30-50% by weight based on the total mass of the pMDI.

The polyisocyanate A1 contains <55% by weight, especially preferably 30-≤50% by weight of monomeric MDI and has a viscosity of 130 to 400 mPa*s at 25° C., preferably of 140 to 400 mPa*s at 25° C. and particularly preferably of 140-300 mPa*s at 25° C. (determined according to DIN 53019-1:2008-09 without solvent). It is particularly preferable to employ a polymeric MDI having the following composition:

35-50% by weight of 4,4′-methylidene diphenyl diisocyanate, 1-10% by weight of 2,4′-methylidene diphenyl diisocyanate, >0% to ≤5% by weight of 2,2′-methylidene diphenyl diisocyanate and 45% to <64% by weight of higher homologs of methylidene diphenyl diisocyanate (having ≥3 aromatic nuclei). It is particularly preferable to employ a composition of 40-50% by weight, in particular 40-46% by weight, of 4,4′-methylidene diphenyl diisocyanate, 1-5% by weight of 2,4′-methylidene diphenyl diisocyanate, >0% to ≤5% by weight of 2,2′-methylidene diphenyl diisocyanate and 45% to <60% by weight of higher homologs of methylidene diphenyl diisocyanate (having ≥3 aromatic nuclei).

The polyisocyanate A1 is subjected to a trimerization reaction [step (1)]. The trimerization reaction is known per se and described for example in WO 2009/039332 A, [00015]-[00021], which is hereby incorporated by reference. Suitable trimerization catalysts include for example Mannich bases of phenol or of phenol derivatives such as for example 2,4,6-tris(dimethylaminomethyl) phenol and 4,4′-isopropylidenebis [2,6-bis(dimethylaminomethyl) phenol], potassium acetate and/or aliphatic quaternary ammonium salts. Iminoureas such as for example 1,1,3,3-tetramethylguanidine are unsuitable as catalyst since the trimerization reaction is then difficult to stop with acid chlorides. Likewise unsuitable as catalyst are free-radical initiators such as especially peroxy and azo compounds since the free-radically induced trimerization reaction is also difficult to stop.

The concentration of the employed trimerization catalyst is <0.50% by weight based on A1, in particular <0.45% by weight, more preferably <0.40% by weight and very particularly preferably <0.30% by weight. At higher concentrations, the trimerization reaction proceeds too rapidly and is difficult to stop at the right time.

The content of isocyanurate groups (in % by weight) in the isocyanate- and isocyanurate-containing composition A2 obtained following the trimerization reaction is determined as follows:

$$Isocyanurate \% ( A2 ) = ( NCO \% ( A 1 ) - NCO \% - ( A 2 ) ) / ( NCO \% ( A 1 ) / 2 ) * 100$$

Determining the weight fraction of NCO groups is carried out according to DIN EN 1242:2013.

The viscosity specifications in this application refer to viscosities determined according to DIN 53019-1 (2008-09) (without solvent).

The composition of the isocyanate- and isocyanurate-containing compositionsA2 and the isocyanate component A is determinable by gel permeation chromatography (GPC) according to DIN 55672-1:2016-03 at 35° C. in tetrahydrofuran as solvent.

The composition A2 or the isocyanate component A has in its GPC a seventh peak (“peak G”, corresponding to the fraction having the seventh lowest molecular weight) whose peak area is preferably >4.6 area %.

The composition A2 or the isocyanate component A preferably has a number-average molecular weight Mn of >350 g/mol.

The composition A2 has
an isocyanate group content of 5-<13% by weight of isocyanurate groups,
a number-average molecular weight Mn of >350 g/mol and
in its GPC a seventh peak corresponding to the fraction having the seventh lowest molecular weight having a peak area of preferably >4.6 area % and
a viscosity of <2000 mPa*s and 25° C., preferably <1000 mPa*s at 25° C.

Compared to the compositions from the prior art the composition A2 produced by the process according to the invention has a lower content of trimerization catalysts and an advantageous molecular weight distribution which manifests in advantageous properties, for example in better surface qualities, in the subsequent processing to afford rigid PUR/PIR foams.

According to the invention the trimerization reaction is terminated in a controlled manner by adding a deactivator (“stopper”). It is possible in principle to employ any acid chloride or any Brønsted acid which is not selected from sulfonic acid, sulfuric acid or derivatives thereof (due to the severe corrosivity of these compounds). Employable acid chlorides include inter alia acetyl chlorides and benzoyl chlorides and mixtures thereof. A preferred example of an acid chloride is benzoyl chloride and a further preferred example is isophthaloyl chloride. Employable acids include inter alia hydrochloric acid, acetic acid, oxalic acid and phosphoric acid. Preference is given to hydrochloric acid, acetic acid and oxalic acid. A particularly preferred example of an acid is hydrochloric acid. The acid chloride or the Brønsted acid may also be used as a solution or dispersion in organic solvents, monomeric MDI or polymeric MDI.

The isocyanate- and isocyanurate-containing composition A2 obtained after step 2) may be used alone or in admixture with further isocyanates for production of polymers, in particular rigid PUR and PUR/PIR foams. It is possible for example to establish a particular viscosity by blending with further polyisocyanates. Suitable therefor are the aliphatic, cycloaliphatic and araliphatic di- and/or polyisocyanates known in polyurethane chemistry and especially aromatic isocyanates. It is especially possible to employ the isomers and oligomers of MDI and TDI.

A further aspect of the present invention is the isocyanate- and isocyanurate-containing compositionA2obtainable by the process according to the invention and an isocyanate component A comprising the composition A2.

The invention likewise relates to a process for producing a rigid PUR/PIR foam by reacting a PUR/PIR system composed of an isocyanate component A and a polyol formulation B in the presence of blowing agents C and catalysts D, wherein the isocyanate component A comprises an isocyanate- and isocyanurate-containing composition A2 according to the invention.

The PUR/PIR systems are preferably used for producing composite elements. Foaming is typically carried out in continuous or discontinuous fashion against at least one outer layer.

The rigid PUR/PIR foams are obtainable by reacting the PUR/PIR system. During the reacting the isocyanate component A and the polyol formulationB are generally reacted in amounts such that the isocyanate index of the foam is ≥250 to ≤450, preferably ≥320 to ≤400.

The isocyanate index here is the quotient calculated from the molar quantity [mol] of isocyanate groups actually used and the molar quantity [mol] of isocyanate groups stoichiometrically required for full conversion of all of the isocyanate-reactive groups, multiplied by 100. Since one mole of an isocyanate group is required for the conversion of one mole of an isocyanate-reactive group, the following equation applies:

index=(moles of isocyanate groups/moles of isocyanate-reactive groups)·100

The isocyanate component A especially has the following properties:
<13% by weight of isocyanurate groups,
20-50% by weight, preferably 20-40% by weight, of monomeric MDI,
NCO content of 23-30% by weight (DIN EN 1242:2013),
in each case based on the total weight of the component A,
and a viscosity of <2000 mPa*s at 25° C., preferably <1000 mPa*s at 25° C.

To produce the isocyanate component A the inventive isocyanate- and isocyanurate-containing composition A2 may optionally be blended with further isocyanates, for example to establish a lower or higher viscosity. In a preferred embodiment the isocyanate- and isocyanurate-containing composition according to the invention A2 is employed without blending with further isocyanates. Suitable isocyanates for blending with the inventive isocyanate- and isocyanurate-containing composition A2 include the customary aliphatic, cycloaliphatic and araliphatic di- and/or polyisocyanates and especially aromatic isocyanates known from polyurethane chemistry. Aromatic isocyanates, especially the homologs and isomers of the MDI series are particularly preferred. The isocyanates suitable for blending may further be selected from polyurethane prepolymers and modified isocyanates. The term “polyurethane prepolymer” especially refers to reactive intermediates in the reaction of isocyanates to afford polyurethane polymers. They are produced by the reaction of a polyol component with an excess of an isocyanate component. Preferred modified isocyanates include: urea-modified isocyanates; biuret-modified isocyanates; urethane-modified isocyanates; isocyanurate-modified isocyanates; allophanate-modified isocyanates; carbodiimide-modified isocyanates; uredione-modified isocyanates and uretonimine-modified isocyanates. Such modified isocyanates are commercially available and are produced by reacting an isocyanate with a sub-stoichiometric amount of an isocyanate-reactive compound or with itself.

It is especially possible to employ the isomers and oligomers of MDI and TDI for blending.

Preferably employable as polyols for polyol formulation B are compounds based on polyesterols or polyetherols. The functionality of the polyetherols and/or polyesterols is generally 1.9 to 8, preferably 1.9 to 7, particularly preferably 1.9 to 6.

The polyols especially have a hydroxyl number of more than 70 mg KOH/g, preferably more than 100 mg KOH/g, particularly preferably more than 120 mg KOH/g. An upper limit of the hydroxyl number that has proven advantageous is generally 1000 mg KOH/g, preferably 900 mg KOH/g, particularly 800 mg KOH/g. The aforementioned OH numbers refer to the entirety of the polyols in the polyol formulation B and do not preclude individual constituents of the mixture from having higher or lower values.

The polyol formulation B preferably contains polyether polyols which are produced from one or more alkylene oxides having 2 to 4 carbon atoms in the alkylene radical by known methods, for example by anionic polymerization catalyzed by alkali metal hydroxides, such as sodium or potassium hydroxide, or alkali metal alkoxides, such as sodium methoxide, sodium or potassium ethoxide or potassium isopropoxide, and with addition of at least one starter molecule containing 2 to 8, preferably 2 to 6, attached reactive hydrogen atoms or by cationic polymerization catalyzed by Lewis acids such as inter alia antimony pentachloride, boron fluoride etherate or fuller's earth. Suitable alkylene oxides include for example tetrahydrofuran, 1,3-propylene oxide, 1,2- and 2,3-butylene oxide, styrene oxide and preferably ethylene oxide and 1,2-propylene oxide. The alkylene oxides may be used individually, alternately in succession or as mixtures. Contemplated starter molecules include alcohols, for example glycerol, trimethylolpropane (TMP), pentaerythritol, sucrose, sorbitol and amines, for example methylamine, ethylamine, isopropylamine, butylamine, benzylamine, aniline, toluidine, toluenediamine, naphthylamine, ethylenediamine, diethylenetriamine, 4,4′-methylenedianiline, 1,3-propanediamine, 1,6-hexanediamine, ethanolamine, diethanolamine, triethanolamine and the like. Also employable as starter molecules are condensation products of formaldehyde, phenol and diethanolamine/ethanolamine, formaldehyde, alkylphenols and diethanolamine/ethanolamine, formaldehyde, bisphenol A and diethanolamine/ethanolamine, formaldehyde, aniline and diethanolamine/ethanolamine, formaldehyde, cresol and diethanolamine/ethanolamine, formaldehyde, toluidine and diethanolamine/ethanolamine and formaldehyde, toluenediamine (TDA) and diethanolamine/ethanolamine and the like. It is preferable when the starter molecules employed are TMP and TDA.

The polyol formulation B may contain crosslinkers as a further constituent. Crosslinkers are understood to be compounds which have a molecular weight of 60 to less than 400 g/mol and at least 3 isocyanate-reactive hydrogen atoms. One example thereof is glycerol. The crosslinkers are generally employed in an amount of 1% to 10% by weight, preferably of 2% to 6% by weight, based on the total weight of the polyol formulation B (but without physical blowing agent).

The polyol formulation B may also contain chain extenders which serve to increase crosslinking density. Chain extenders are understood to be compounds which have a molecular weight of 60 to less than 400 g/mol and at least 2 isocyanate-reactive hydrogen atoms. Examples include butanediol, diethylene glycol, dipropylene glycol and ethylene glycol. The chain extenders are generally employed in an amount of 2% to 20% by weight, preferably of 4% to 15% by weight, based on the total weight of the polyol formulation B (but without physical blowing agent).

Crosslinkers and chain extenders may be employed in the polyol mixture individually or in combination.

Production of the rigid PUR/PIR foams further employs chemical and/or physical blowing agents (C).

Preferred chemical blowing agents include water or carboxylic acids, especially formic acid. The chemical blowing agent is generally employed in an amount of 0.1% to 5% by weight, especially of 1.0% to 3.0% by weight, based on the weight of component B.

The term physical blowing agents is to be understood as meaning compounds that are dissolved or emulsified in the starting materials of polyurethane production and vaporize under the conditions of polyurethane formation. Examples include hydrocarbons, halogenated hydrocarbons, and other compounds such as for example perfluorinated alkanes, such as perfluorohexane, hydrochlorofluorocarbons and ethers, esters, ketones and/or acetals. These are typically employed in an amount of 1% to 30% by weight, preferably 2% to 25% by weight, particularly preferably 3% to 20% by weight, based on the total weight of component B.

Production of the rigid PUR/PIR foams further employs catalysts D. Employed catalysts D for accelerating the reaction of the hydroxyl-containing compounds of component B with the isocyanate groups of component A are typically and preferably organotin compounds, such as tin (II) salts of organic carboxylic acids and/or basic amine compounds, preferably tertiary amines, for example triethylamine and/or 1,4-diaza-bicyclo-(2,2,2)-octane. Catalysts D used for forming isocyanurate groups in the production of the rigid PUR/PIR foams are typically selected from metal carboxylates, preferably potassium acetate or potassium octoate, and solutions thereof Rigid PUR/PIR foams employ a mixture of catalysts for accelerating the reaction of the hydroxyl-containing compounds of component B with the isocyanate groups of component A and of catalyst for forming isocyanurate groups. The catalysts are generally employed in an amount of 0.001% to 5% by weight of catalyst based on the weight of component B.

The PUR/PIR system may optionally also be admixed with further auxiliary and/or additive substances E. These are to be understood as meaning auxiliary and additive substances known and customary in the prior art. These may be added to the polyol component B or directly to the reaction mixture. They include for example surface-active substances, foam stabilizers, cell regulators, fillers, dyes, pigments, flame retardants, antistats, antihydrolysis agents and/or fungistatic and bacteriostatic substances.

The invention likewise relates to a rigid PUR/PIR foam obtainable by a process according to the invention. In the context of the present invention rigid PUR/PIR foams are especially PUR/PIR foams whose apparent density according to DIN EN ISO 3386-1-98 (September 2010) is in the range from 15 kg/m³ to 300 kg/m³ and whose compression strength according to DIN EN 826 (May 1996) is in the range from 0.1 MPa to 3 MPa.

It has surprisingly been found that these rigid PUR/PIR foams have an improved stackability compared to rigid foams produced with a conventional MDI or a pMDI having a relatively high isocyanurate content. This is measured in the form of the impression depth at a defined weight and defined piston area (for description see experimental part) after production and thus correlates with curing rate. At the same time the rigid PUR/PIR foams also exhibit a very good storage stability and foam properties, improved flame retardancy and have few defects in the produced panels. The rigid PUR/PIR foams according to the invention also have advantages in terms of their water absorption properties.

The rigid PUR/PIR foam according to the invention is thus advantageously employable as insulation foam in the production of composite elements.

The invention likewise relates to a composite element comprising a rigid foam layer containing a rigid PUR/PIR foam according to the invention and at least one outer layer. The outer layer is in this case at least partially contacted by a layer comprising the rigid PUR/PIR foam according to the invention. The material of the outer layer is typically aluminum, steel, bitumen, paper, a mineral nonwoven fabric, a nonwoven fabric comprising organic fibres, a plastic sheet, a plastic film and/or a wooden sheet.

In another embodiment of the composite element this is in the form of an insulation panel.

### EXAMPLES

### Experimental Section

### Methods Employed:

Mold temperature: Temperature in ° C. of the mold used for foaming.
Mixing time: the time in seconds over which the reaction mixture is mixed.
Cream time: time in seconds that elapses from commencement of mixing to the detectable start of the reaction.
Fiber time: time in seconds that elapses from commencement of mixing to the solidification of the foam surface.
Tack-free time: time in seconds that elapses from commencement of mixing until the foam surface no longer feels tacky.
Impression depth (after a certain time): The impression depth test is performed on freshly produced laboratory foams in test packages having a base area of 20×20 cm². The penetration depth of a piston having a diameter of 3.5 cm and a piston weight of 6 kg is determined after the specified time periods during the curing phase.
Cell size: Scale between 1 and 6; where 1 means very fine or very uniform and 6 means very coarse or irregular
Surface/foam inner surface: qualitative distinction between brittle, sandy and tough
Apparent core density: DIN EN ISO 845:2009 “Foams of rubber and plastics-determination of apparent density”
Isocyanate content: DIN EN 1242:2013 “Determination of isocyanate content”
Viscosity: DIN 53019-1:2008 “Viscometry-Measurement of viscosities and flow curves with rotational viscometers”. The measurement was carried out without solvent.
Hydroxyl number (OH number): determination of OH number was carried out according to the specification of DIN 53240-2:2007.

Dimensional stability (dim. stab.): The foam specimen is stored at 20-25° C. for at least 24 h before two foam cubes having dimensions of 10·10·10 cm³ are removed from the core. After marking the three spatial directions of each cube these were measured with a calliper and stored at −22° C. and 100° C. respectively for 24 hours. The cubes are then measured again at room temperature. Dimensional stability is the percentage change of the edge length ΔL of all three spatial directions A, B and C, where C always corresponds to the foaming direction. ΔL=(L−OL)/OL·100% where L =edge length of the test specimen after storage and OL=edge length of the test specimen before storage. A foam has passed this test if the change in each direction at −22° C. and 100° C. is below 1%.

Water absorption: A cube of 90 mm×90 mm×60 mm is weighed and immersed in water in a dessicator and evacuated to 100 mbar for 60 seconds. Excess water is then drained and water absorption determined by weighing.

Swiss fire test: Test according to Fire Protection Directive No. 585.113 of the Association of Cantonal Fire Insurance Companies VKF (SAR 585.113; Switzerland; 23 Mar. 2015; Appendix 5 to Fire Protection Ordinance).

SBT: (Small burner test) Flame retardancy test according to DIN EN ISO 11925-2 (2020-07) for classification of flame retardant properties

Compression Strength: Compression strength at 10% compression in running direction according to DIN EN 826-01 (2013-05)

Thermal conductivity: Thermal conductivity according to DIN EN 12667-01 (2001-05) (at 10° C. or 70° C., 0-value); 0-value is to be understood as meaning that measurements are taken directly after production without prior storage.

The content of isocyanurate groups in ISOCYANATES 1, 2 and 3 is determined by the following equation:

Isocyanurate % (ISOCYANATE 1, 2 or 3)=(NCO % (input material)-NCO % (ISOCYANATE 1, 2 or 3))/(NCO % (input material)/2)*100; where NCO % (input material) is the NCO content of the employed polyisocyanate A1 (MDI200/MDI100).

Storage test: The storage stability of the isocyanates was evaluated qualitatively by storing the specimens in the laboratory at room temperature for a period of 3 months and visually evaluating them.

GPC Gel permeation chromatography: The content of the different species was determined by gel permeation chromatography (GPC) according to DIN 55672-1:2016-03 at 35° C. in tetrahydrofuran solvent (SECurity GPC system from PSS Polymer Service, flow rate 0.6 ml/min; columns: 2×PSS SDV 50A 5 μm, 2×PSS SDV 100A 5 μm, 8×300 mm; RI detector). Samples of polystyrene standards of known molecular weight were used for calibration. Calculation of number-average molecular weight was performed using PSSWin GPC software. In the chromatogram, the peaks are named as shown in the FIGURE. The peak with the seventh lowest molecular weight is given the designation “Peak G”.

### Materials Used:

MDI100: Desmodur 44V10L, polymeric diphenylmethane diisocyanate (Covestro Deutschland AG); isocyanate content 31.8% by wt., viscosity at 25° C. about 100 mPas,
MDI200: Desmodur 44V20L, polymeric diphenylmethane diisocyanate (Covestro Deutschland AG); isocyanate content 31.5% by wt., viscosity at 25° C. about 200 mPas
MDI700: Desmodur 44V70L, polymeric diphenylmethane diisocyanate (Covestro Deutschland AG); isocyanate content 30.9% by wt., viscosity at 25° C. about 700 mPas,
Benzoyl chloride: obtained from Sigma-Aldrich; 99.5%; boiling point 198° C.
Tris(dimethylaminomethyl) phenol: obtained from Sigma-Aldrich 95%; refractive index n20/D 1.516, boiling point: 130-135° C.
POLYOL 1: aromatic polyester polyol (Synthesia Technology) having an OH number of 240 mg/kg KOH, a functionality determined from the raw materials of 1.9 and a viscosity of 1500 mPa*s at 25° C.
POLYOL 2: polyether diol (Covestro) having an OH number of 28 mg/kg KOH and a viscosity of 860 mPa*s at 25° C., produced with 1,2-propylene glycol as the starter and a mixture of ethylene oxide and propylene oxide in a ratio of 30 to 70 parts by weight
POLYOL 3: aromatic polyester polyol (Covestro) having an OH number of 370 mg/kg KOH, a functionality determined from the raw materials of 1.9 and a viscosity of 1400 mPa*s at 25° C.
POLYOL 4: aromatic polyester polyol (Covestro) having an OH number of 795 mg/kg KOH, a functionality determined from the raw materials of 2.0 and a viscosity of 1400 mPa*s at 25° C.
POLYOL 5: aromatic polyester polyol (Stepan Company) having an OH number of 240 mg/kg KOH, an acid number of 0.8 and a viscosity of 3000 mPa*s at 25° C.
POLYOL 6: polyether diol (Covestro) having an OH number of 35 mg/kg KOH and a viscosity of 860 mPa*s at 25° C. produced with glycerol as the starter and ethylene oxide and propylene oxide in a ratio of 13 to 87 parts by weight, wherein the ethylene oxide is added as a second block.
Diethylene glycol: diethylene glycol (Aldrich)
Triethyl phosphate: flame retardant (Lanxess)
Disflamol DPK: flame retardant (Lanxess)
Tegostab B8443: foam stabilizer (Evonik)
DABCO LK443: foam stabilizer (Evonik)
Desmorapid 1792: potassium acetate catalyst (Covestro)
Desmorapid DB: benzyldimethylamine catalyst (Covestro)
Desmorapid VP. PU1221 VN: catalyst (Covestro)
Desmorapid 1118: catalyst (Covestro)
Tetramethylguanidine: 1,1,3,3-tetramethylguanidine (Aldrich)
n-Pentane: n-pentane blowing agent (Aldrich)
Cyclopentane: cyclopentane blowing agent (Aldrich)
Isopentane: isopentane blowing agent (Aldrich)
ADHESION PROMOTER: 2K adhesion promoter (Covestro)
TCPP: Fyrol PCF flame retardant (ICL)
Tegostab B8421: foam stabilizer (Evonik)
Desmorapid PV: pentamethyldiethylenamine catalyst (Covestro)
Kosmos 75 MEG: potassium octoate catalyst (Biesterfeld)
POLYOL MIXTURE 1: a mixture composed of the following components:

| | | |
|---|---|---|
| POLYOL 1 | parts by | 79 |
| | wt. | |
| POLYOL 2 | parts by | 10 |
| | wt. | |
| TRIETHYL | parts by | 8 |
| PHOSPHATE | wt. | |
| TEGOSTAB B8443 | parts by | 2.5 |
| | wt. | |
| POLYOL 3 | parts by | 2 |
| | wt. | |
| POLYOL 4 | parts by | 0.5 |
| | wt. | |
| WATER | parts by | 0.5 |
| | wt. | |

### Example 1: Production of ISOCYANATE 1 (Inventive)

99.80 parts by weight of MDI200 are initially charged under dry nitrogen and heated to 60° C. 0.17 parts by weight of tris(dimethylaminomethyl) phenol are added. The reaction temperature is kept constant at 60+/−2° C. Upon achieving the target viscosity of 700 mPas at 25° C. 0.03 parts by weight of benzoyl chloride are added and the mixture is stirred at 60° C. for 20 min. Viscosity, NCO content and isocyanurate group content of ISOCYANATE 1:678 mPas at 25° C.; NCO content: 29.92% NCO; 10.0% by weight isocyanurate groups.

The GPC of ISOCYANATE 1 is shown in the FIGURE—table 1 shows the comparison of peak areas and number-average molecular weights obtained from the gel permeation chromatograms of ISOCYANATE 1 and ISOCYANATE 2.

The area corresponding to Peak G is 5.0 area %.

The number-average molecular weight Mn is 356 g/mol.

### Example 2a*: Production of ISOCYANATE 2 (Comparison of Redilution, Noninventive)

99.80 parts by weight of MDI200 are initially charged under dry nitrogen and heated to 60° C. 0.17 parts by weight of tris(dimethylaminomethyl) phenol are added. The reaction temperature is kept constant at 60+/−2° C. Upon achieving the target viscosity of 3000 mPas at 25° C. 0.03 parts by weight of benzoyl chloride are added and the mixture is stirred at 60° C. for 20 min. Viscosity of intermediate product: 3360 mPas at 25° C.; intermediate NCO content: 28.52% of NCO

After termination of the trimerization reaction 94.97 parts by weight of MDI200 are subsequently added to establish the same viscosity and trimer content as in ISOCYANATE 1. The ISOCYANATE 2 obtained after mixing has a viscosity of 705 mPas at 25° C., an NCO content of 29.91% NCO and 10.0% by weight isocyanurate groups.

The area corresponding to Peak G is 4.4 area %.

The number-average molecular weight Mn is 346 g/mol.

### Example 2b*: Production of ISOCYANATE 3 (Relatively Low Viscosity Comparison, DE 691 16 583 T2, Noninventive)

99.80 parts by weight of MDI100 are initially charged under dry nitrogen and heated to 60° C. 0.17 parts by weight of tris(dimethylaminomethyl) phenol are added. The reaction temperature is kept constant at 60+/−2° C. In the case of an NCO drop of about 1.5% NCO (corresponds to about 10% by weight of isocyanurate groups) 0.03 parts by weight of benzoyl chloride are added and the resulting mixture is stirred at 60° C. for 20 min. Viscosity, NCO content and isocyanurate group content of ISOCYANATE 3:355 mPas at 25° C.; NCO content: 29.98% NCO; 11.4% by weight isocyanurate groups.

### Example 2c*: Production of ISOCYANATE 4 (Iminourea Catalyst Comparison, DE 691 16 583 T2. Noninventive)

99.80 parts by weight of MDI200 are initially charged under dry nitrogen and heated to 60° C. 0.17 parts by weight of tetramethylguanidine are added. The reaction temperature is kept constant at 60+/−2° C. In the case of an NCO drop of about 1.5% NCO (corresponds to about 10% by weight of isocyanurate groups) 0.03 parts by weight of benzoyl chloride are added and the resulting mixture is stirred at 60° C. for 20 min. The reaction did not stop after addition of benzoyl chloride. The reaction mixture was subsequently cooled to room temperature. Again, the reaction did not stop but continued so that a solid was present after 24 h.

TABLE 1
Comparison of peak areas and number-average molecular
weights obtained from gel permeation chromatograms
of ISOCYANATE 1 and ISOCYANATE 2*.

| | | | Elution | Molecular | ISOCYANATE | ISOCYANATE |
|---|---|---|---|---|---|---|
| | | | volume | weight | 1 | 2* |
| | Units | Peak | [ml] | [Da] | F [%] | F [%] |
| | | A | 36.23 | 196.0 | 33.5 | 34.7 |
| | | B | 35.3 | 248.9 | 0.1 | 0.1 |
| | | C | 33.98 | 350.3 | 18.4 | 19.4 |
| | | D | 32.71 | 496.6 | 9.1 | 9.6 |
| | | E | 31.78 | 652.7 | 5.1 | 5.4 |
| | | F | 31.15 | 785.2 | 4.8 | 4.3 |
| | | G | 30.58 | 929.1 | 5.0 | 4.4 |
| | | H | 30.09 | 1070.4 | 4.1 | 3.7 |
| | | I | 29.66 | 1208.7 | 3.1 | 3.0 |
| | | J | 29.43 | 1284.9 | 2.4 | 2.8 |
| | | K | 29.09 | 1410.8 | 14.4 | 12.6 |
| Mn | [g/ | | | | 356 | 346 |
| | mol] | | | | | |

### Examples 3-6: Production of PUR/PIR Foams

The thus produced isocyanate- and isocyanurate-containing compositions ISOCYANATE 1 and 2 are used for production of rigid PUR/PIR foams and compared with a standard isocyanurate-free polyisocyanate composition of similar viscosity. In table 2 which follows the same polyol formulation is in each case foamed with the isocyanate- and isocyanurate-containing composition ISOCYANATE 1 in inventive example 5, with the composition containing only isocyanate groups MDI700 in the comparative examples example 3* and example 4* and with the isocyanate- and isocyanurate-containing composition ISOCYANATE 2 in comparative example 6*. For better comparability, the isocyanate compositions were in each case replaced in identical parts by weight, thus resulting in slight variations in the index.

TABLE 2
Laboratory foaming

| | | Exam- | Exam- | Exam- | Exam- |
|---|---|---|---|---|---|
| | | ple | ple | ple | ple |
| Parameter | Units | 3* | 4* | 5 | 6* |
| POLYOL 1 | parts by wt. | 79 | 79 | 79 | 79 |
| POLYOL 2 | parts by wt. | 10 | 10 | 10 | 10 |
| Triethyl | parts by wt. | 8 | 8 | 8 | 8 |
| phosphate | | | | | |
| Tegostab B8443 | parts by wt. | 2.5 | 2.5 | 2.5 | 2.5 |
| POLYOL 3 | parts by wt. | 2 | 2 | 2 | 2 |
| POLYOL 4 | parts by wt. | 0.5 | 0.5 | 0.5 | 0.5 |
| water | parts by wt. | 0.5 | 0.5 | 0.5 | 0.5 |
| Desmorapid 1792 | parts by wt. | 2.7 | 2.7 | 2.7 | 2.7 |
| Desmorapid DB | parts by wt. | 1.1 | 1.1 | 1.1 | 1.1 |
| n-Pentane | parts by wt. | 13.5 | 13.5 | 13.5 | 13.5 |
| MDI700 | parts by wt. | 205 | 205 | | |
| ISOCYANATE | parts by wt. | | | 205 | |
| 1 | | | | | |
| ISOCYANATE | parts by wt. | | | | 205 |
| 2* | | | | | |
| Index (100 | | 329 | 329 | 319 | 319 |
| NCO/OH) | | | | | |
| Mold temperature | ° C. | 60 | 60 | 60 | 60 |
| Mixing time | s | 6 | 6 | 6 | 6 |
| Cream time | s | 11 | 12 | 11 | 12 |
| Fiber time | s | 32 | 33 | 31 | 31 |
| Tack-free time | s | 45 | 45 | 40 | 40 |
| Impression | mm | 7.3 | 7.0 | 5.1 | 4.1 |
| depth (2.5 min) | | | | | |
| Impression | mm | 8.3 | 8.0 | 5.7 | 4.6 |
| depth (5 min) | | | | | |
| Apparent core | kg/m³ | 39.4 | 40.8 | 38.7 | 38.7 |
| density | | | | | |
| Dimensional | % | 0.0/ | −0.1/ | 0.0/ | 0.0/ |
| stability after | | −0.1/ | 0.0/ | 0.0/ | 0.3/ |
| 24 h, −22° C. | | 0.0 | 0.1 | 0.0 | 0.1 |
| Dimensional | % | −0.3/ | −0.4/ | −0.3/ | −0.3/ |
| stability after | | −0.2/ | −0.1/ | −0.6/ | −0.6/ |
| 24 h, −100° C. | | −0.4 | −0.3 | −0.6 | −0.4 |
| Cell size (internal, | | 2 | 2 | 2 | 2 |
| slice) | | | | | |
| Embrittlement | | TOUGH | TOUGH | TOUGH | TOUGH |
| after 24 h, | | | | | |
| (internal, slice) | | | | | |
| SBT/Classification | | E | E | E | E |
| Average max. | mm | 120 | 130 | 116 | 138 |
| flame height | | | | | |
| Min-max flame | mm | 120-120 | 130-130 | 110-125 | 130-140 |
| height | | | | | |
| Average destroyed | mm | 71.3 | 70 | 66.3 | 70 |
| specimen | | | | | |
| length | | | | | |
| RT storage test | | ok | ok | ok | ok |
| over 3 months | | | | | |

The experiments show that the use of the inventive isocyanate- and isocyanurate-containing composition ISOCYANATE 1 makes it possible to produce rigid PUR/PIR foams by weight-fractional replacement of the conventional pMDI (i.e. without adapting the index), wherein the rigid PUR/PIR foams are not inferior to those produced from conventional pMDI upon comparison of their physical/mechanical properties and their performance characteristics and are clearly superior in terms of their penetration depth after 2.5 minutes and 5 minutes (example 5). Noninventive example 6*shows that while a re-dilution of a very high-viscosity trimerized pMDI (viscosity greater than 2000 mPas at 25° C. before dilution, see production of ISOCYANATE 2) to afford an isocyanate- and isocyanurate-containing composition of about 700 mPas (ISOCYANATE 2) does result in the same advantages in terms of penetration depth after 2.5 minutes and 5 minutes the rigid PUR/PIR foam does not exhibit such good properties in the fire test.

### Examples 7-9: Production of Composite Elements Having a Steel Outer Layer on a Double Belt

The isocyanate components ISOCYANATE 1, ISOCYANATE 2 and MDI700 were in each case subjected to tests on an industrial scale on a double conveyor belt with a steel outer layer (so-called metal panel; table 3). The test conditions, input materials and results are summarized in table 3.

The results show that the use of the inventive isocyanate- and isocyanurate-containing composition ISOCYANATE 1 makes it possible to produce composite elements comprising rigid PUR/PIR foams which have comparable physical/mechanical properties and performance characteristics by weight-fractional replacement of the conventional pMDI (i.e. without adapting the index) (example 8). Noninventive example 9*shows that while the use of a re-dilution of a very high-viscosity trimerized pMDI (viscosity greater than 2000 mPas at 25° C. before dilution, see production of ISOCYANATE 2) to afford an isocyanate- and isocyanurate-containing composition of about 700 mPas (ISOCYANATE 2) does result in identical mechanical properties it also results in undesired defects at the sheet-metal underside and leads to a rather poorer fire test result.

TABLE 3
Composite elements having a steel outer layer on the double belt

| | | Exam- | Exam- | Exam- |
|---|---|---|---|---|
| Parameter | | ple 7* | ple 8 | ple 9* |
| Outer layer temp. | [° C.] | 35-40/ | 35-40/ | 35-40/ |
| (top/bottom) | | 35-40 | 35-40 | 35-40 |
| Belt temperature | [° C.] | 60/60 | 60/60 | 60/60 |
| (top/bottom) | | | | |
| Corona (top/bottom) | | off/on | off/on | off/on |
| Corona power (top/bottom) | [kW] | off/4 | off/4 | off/4 |
| Profiling (top/bottom) | | on/on | on/on | on/on |
| ADHESION PROMOTER | | yes | yes | yes |
| Adhesion promoter | [g/m²] | 100 | 100 | 100 |
| total application | | | | |
| rate | | | | |
| Plate thickness/width | [mm] | 200/1000 | 200/1000 | 200/1000 |
| Index (100 NCO/OH) | | 332 | 331 | 330 |
| POLYOL MIXTURE 1 | parts by | 100.0 | 100.0 | 100.0 |
| | wt. | | | |
| Tegostab B 8443 | parts by | 2.5 | 2.5 | 2.5 |
| | wt. | | | |
| Desmorapid DB | parts by | 1.8 | 1.8 | 1.8 |
| | wt. | | | |
| Desmorapid 1792 | parts by | 2.0 | 1.8 | 1.8 |
| | wt. | | | |
| n-Pentane | parts by | 14.2 | 14.4 | 14.4 |
| | wt. | | | |
| MDI700 | parts by | 200 | | |
| | wt. | | | |
| ISOCYANATE 1 | parts by | | 205 | |
| | wt. | | | |
| ISOCYANATE 2 | parts by | | | 205 |
| | wt. | | | |
| Foam formulation | [kg/min] | 27.20 | 27.20 | 27.20 |
| total application rate | | | | |
| Cream time | [s] | 12-13 | 12 | 12 |
| Fiber time | [s] | 39 | 40 | 39 |
| Tack-free time | [s] | 55 | 60 | 56 |
| Apparent sheet density | [kg/m³] | 37.9 | 37.5 | 37.5 |
| (DIN EN ISO 845) | | | | |
| Outer layer temperature | | 38/38 | 38/38 | 38/38 |
| (top/bottom) | | | | |
| Hardness at belt outlet | | good | good | good |
| Thermal conductivity | [mW/Km] | 20.52 | 20.53 | 20.61 |
| (10° C., 0-value) | | | | |
| Dimensional stability | [%] | −0.1/ | 0.1/ | 0.1/ |
| after 24 h, 100° C. | | −0.8/1.5 | −0.9/1.4 | −0.9/1.2 |
| Dimensional stability | [%] | 0.1/ | 0.2/ | 0.2/ |
| after 24 h, −22° C. | | 0.0/0.1 | 0.0/0.1 | 0.0/0.1 |
| Defects on sheet | | Defect- | Defect- | Defect- |
| metal (top surface) | | free | free | free |
| Defects on | | Defect- | Defect- | Voids |
| sheet metal (bottom | | free | free | |
| surface) | | | | |
| Swiss fire test | | | | |
| BVD according to | | | | |
| SAR 585.113 | | | | |
| Flammability | | 3 | 3 | 3 |
| Average flame height | [mm] | 155 | 145 | 157 |
| Extreme values | [mm] | 150-160 | 140-150 | 155-160 |

### Examples 10-12: Production of Composite Elements Having an Aluminum Top Layer on a Double Belt

The industrial-scale tests on a double conveyor belt with an aluminum outer layer (so-called insulation boards; table 4) show that the use of the inventive isocyanate- and isocyanurate-containing composition ISOCYANATE 1 makes it possible to produce composite elements comprising rigid PUR/PIR foams which have comparable physical/mechanical properties and performance characteristics (example 11) by weight-fractional replacement of the conventional pMDI (i.e. without adapting the index). Noninventive example 12* shows that while the use of a re-diluted trimerized pMDI having a very high viscosity before re-dilution (viscosity greater than 2000 mPas at 25° C. before dilution, see production of ISOCYANATE 2) to afford an isocyanate- and isocyanurate-containing composition of about 700 mPas (ISOCANATE 2) does result in identical mechanical properties it also results in undesired defects at the outer layer and the compression strength in inventive example 11 is superior to both comparative example 10* with conventional pMDI and comparative example 12*

The tests on a laboratory scale (so-called insulation boards, table 5) show that the use of the inventive isocyanate- and iscocyanurate-containing composition ISOCYANATE 1 shows advantages in both impression depth after 3 min and 5 min and water absorption (example 13) compared to the noninventive ISOCYANATE 3 (comparison with DE 691 16 583 T2, example 14*). This is due to the high content of monomeric diphenylmethane diisocyanate. The MDI100 used here is similar to the isocyanate used as input material in DE 691 16 583 T2. In comparative example 14* the use of the MDI100 brings about the low functionality of the noninventive ISOCYANATE 3.

To summarize, it must be noted that compared to the conventional MDI700 and to the noninventive isocyanurate-containing composition ISOCYANATE 2 the use of the inventive isocyanate- and isocyanurate-containing composition ISOCYANATE 1 brings advantages in terms of the stackability of the foam sheets/the initial strength measured as impression depth after 2.5 minutes and 5 minutes, in terms of the quality of the composite elements (especially the surfaces) and in terms of flame retardancy.

TABLE 4
Foaming on double conveyor belt with aluminum outer layers

| | | Example | Example | Example |
|---|---|---|---|---|
| Parameter | Units | 10* | 11 | 12* |
| POLYOL 5 | parts by wt. | 83.4 | 83.4 | 83.4 |
| TCPP | parts by wt. | 16.6 | 16.6 | 16.6 |
| water | parts by wt. | 1.3 | 1.3 | 1.3 |
| B8421 | parts by wt. | 2.2 | 2.2 | 2.2 |
| Desmorapid PV | parts by wt. | 1.1 | 1.1 | 1.1 |
| Desmorapid 1792 | parts by wt. | 0.5 | 0.5 | 0.5 |
| Kosmos 75 MEG | parts by wt. | 4.2 | 4.2 | 4.2 |
| Cyclopentane | parts by wt. | 4.7 | 4.7 | 4.7 |
| Isopentane | parts by wt. | 10.9 | 10.9 | 10.9 |
| MDI700 | parts by wt. | 245.9 | | |
| ISOCYANATE 1 | parts by wt. | | 245.9 | |
| ISOCYANATE 2 | parts by wt. | | | 245.9 |
| Index (100 | | 324.0 | 314.0 | 314.0 |
| NCO/OH) | | | | |
| Belt speed | [m/min] | 12.5 | 12.5 | 12.5 |
| Cream time | [s] | 3 | 3 | 5 |
| Fiber time | [s] | 10 | 11 | 11 |
| Tack-free time | [s] | 15 | 15 | 16 |
| Contact time | [s] | 8 | 9 | 9 |
| Sheet thickness | [mm] | 100 | 100 | 100 |
| Dimensional | [%] | −0.3/ | −0.3/ | −1.0/ |
| stability | | −0.5/0.2 | −0.5/1.0 | −0.4/0.4 |
| after 24 h, 100° C. | | | | |
| Dimensional | [%] | 0.0/ | 0.0/ | 0.1/ |
| stability | | 0.1/−0.1 | 0.1/−0.3 | 0.1/0.0 |
| after 24 h, −22° C. | | | | |
| Compression | 10% value | 0.149 | 0.163 | 0.148 |
| Strength | [MPa] | | | |
| | Elastic | 3.7 | 4.0 | 3.7 |
| | modulus | | | |
| | [MPa] | | | |
| Apparent sheet | [kg/m³] | 29.52 | 29.57 | 29.11 |
| density | | | | |
| Thermal | [mW/Km] | 19.6 | 19.7 | 19.7 |
| conductivity | | | | |
| (70° C., 0 value) | | | | |
| SBT | Classification | E | E | E |
| max. flame height | [mm] | 100 | 93 | 99 |
| Defects at outer | | low | low | significant |
| layer | | | | |
| (upper surface) | | | | |
| Defects at | | low | low | inter- |
| outer layer | | | | mediate |
| (lower surface) | | | | |

TABLE 5
Laboratory foaming

| | | Example | Example |
|---|---|---|---|
| Parameter | Units | 13 | 14* |
| DISFLAMOL DPK | parts by | 11.6 | 11.6 |
| | wt. | | |
| POLYOL 6 | parts by | 10 | 10 |
| | wt. | | |
| DEG | parts by | 3.4 | 3.4 |
| | wt. | | |
| water | parts by | 1.2 | 1.2 |
| | wt. | | |
| DABCO LK443 | parts by | 1 | 1 |
| | wt. | | |
| POLYOL 4 | parts by | 1.8 | 1.8 |
| | wt. | | |
| Desmorapid VP. PU1221 VN | parts by | 1.2 | 1.2 |
| | wt. | | |
| Desmorapid 1118 | parts by | 3.6 | 3.6 |
| | wt. | | |
| Cyclopentane/isopentane 70/30 | parts by | 13.8 | 13.8 |
| | wt. | | |
| ISOCYANATE 1 | parts by | 100 | |
| | wt. | | |
| ISOCYANATE 3 | parts by | | 100 |
| | wt. | | |
| Index (100 NCO/OH) | | 267 | 272.1 |
| Cream time | [s] | 21 | 20 |
| Fiber time | [s] | 57 | 55 |
| Tack-free time | [s] | 120 | 110 |
| Dimensional stability | | 0.4/0.3/−0.3 | 0.3/0.6/−0.1 |
| after 24 h, 100° C. | | | |
| Dimensional stability | [%] | −0.1/0.1/0.1 | 0.0/−0.1/0.3 |
| after 24 h, −22° C. | | | |
| Impression depth (3 min) | [mm] | −10.3 | −16.4 |
| Impression depth (5 min) | [mm] | −11.1 | −17.0 |
| Water absorption | | 9.5 | 11.7 |
| Apparent core density | [kg/m³] | 37.4 | 34.8 |
| SBT/Classification | | E | E |
| SBT/Average max. Flame | [mm] | 101 | 101 |
| height | | | |

1. A process for producing an isocyanate- and isocyanurate-containing composition A2 comprising the steps of:
1. reacting a polyisocyanate A1 in the presence of a trimerization catalyst, and
2. stopping the reaction from step 1) using a suitable stopper to obtain the composition A2;
wherein the trimerization catalyst is not an iminourea, a derivative of an iminourea or a free-radical initiator and the concentration of the employed trimerization catalyst is <0.50% by weight based on A1, and
wherein the polyisocyanate A1 employed in step 1) is polymeric MDI having a content of monomeric diphenylmethane diisocyanate of <55% by weight and a viscosity of 130 to 400 mPa*s, at 25° C. as determined according to DIN 53019-1:2008-09 without solvent, and
wherein step 2) is performed when the reaction mixture from step 1) comprises 5-<13% by weight of isocyanurate groups and has a viscosity of <2000 mPa*s at 25° C. as determined according to DIN 53019-1:2008-09 without solvent.

2. The process as claimed in claim 1, wherein the employed polyisocyanate A1 comprises ≤50% by weight of monomeric MDI and/or has a viscosity of 140 to 300 mPa*s at 25° C. as determined according to DIN 53019-1:2008-09 without solvent.

3. The process as claimed in claim 1, wherein the stopper is a compound selected from acid chlorides or Brønsted acids with the proviso that it is not sulfonic acid, sulfuric acid or derivatives of these acids.

4. An isocyanate- and isocyanurate-containing composition A2 obtainable by a process as claimed in claim 1.

5. The composition A2 as claimed in claim 4, wherein the composition A2 has in its gel permeation chromatography (GPC) a seventh peak corresponding to the fraction having the seventh lowest molecular weight whose peak area is >4.6 area %.

6. The composition A2 as claimed in claim 4, having a number-average molecular weight Mn of >350 g/mol.

7. The composition A2 as claimed in claim 4, wherein the composition A2 has a viscosity of <1000 mPa*s at 25° C. as determined according to DIN 53019-1:2008-09 without solvent.

8. An isocyanate component A comprising the composition A2 as claimed in claim 4.

9. A PUR/PIR system for producing a rigid PUR/PIR foam from the isocyanate component A as claimed in claim 8 and a polyol formulation B in the presence of blowing agents C.

10. The PUR/PIR system as claimed in claim 9, wherein the isocyanate index of the foam is ≥250 to ≤450.

11. A process for producing a rigid PUR/PIR foam by reacting a PUR/PIR system as claimed in claim 9.

12. The rigid PUR/PIR foam obtainable by a process as claimed in claim 11.

13. A method comprising producing composite elements with the rigid PUR/PIR foam as claimed in claim 12 as insulation foam.

14. A composite element comprising a rigid foam layer containing the rigid PUR/PIR foam as claimed in claim 12 and at least one outer layer.

15. The composite element as claimed in claim 14, wherein the material of the outer layer is aluminum, steel, bitumen, paper, a mineral nonwoven fabric, a nonwoven fabric comprising organic fibres, a plastic sheet, a plastic film and/or a wooden sheet.

16. The PUR/PIR system for producing a rigid PUR/PIR foam as claimed in claim 8, further comprising catalysts D and additive substances E.
